(19) United States
(12) Patent Application Publication
(10) Pub. No.: US 2003/0208637 A1
(43) Pub. Date: Nov. 6, 2003

(54) Application layer interface

(75) Inventor: Matthew A. Hayduk, Calgary (CA)

Correspondence Address: Schwegman, Lundberg,, Woessner & Kluth, P.A., P.O. Box 2938, Minneapolis, MN, 55402, US

(73) Assignee: Intel Corporation

(21) Appl. No.: 10/137,966

(22) Filed: May 3, 2002

(51) Int. Cl. G06F 9/46

(52) U.S. Cl. 709/320; 709/313

(57) ABSTRACT

An applications layer interface, a method of coupling an applications subsystem to a communications subsystem, and various articles comprising a machine-accessible medium are disclosed. The application layer interface may include an applications subsystem and a communications control interface (CCI), which may in turn have interfaces for sockets and telephony. The application layer interface also may include a communications subsystem and a communication control protocol (CCP). The CCI is capable of being communicatively coupled to the application subsystem and the communications subsystem. The method may include providing a CCI between the applications subsystem and the communications subsystem, accessing a communications service by using the CCI to send a request to a service access controller (SAC), granting access to the communications service, and exchanging data between the applications subsystem and the communications subsystem.

### FIELD OF THE INVENTION

The present invention relates generally to computer operating systems, interfaces, and communications protocols. More particularly, the present invention relates to apparatus, methods, and computer programs for conducting peripheral operations which, to various, degrees, separate hardware and software functionality.

### BACKGROUND INFORMATION

Consumers continue to adopt wireless phones and internet use at an increasing rate. By 2004, it is estimated that there will be 1.4 billion cellular telephone subscribers; more than 560 million of them will have internet access. The power and ubiquity of the internet is therefore rapidly changing the way people communicate, work, and live, as well as the marketplace for hardware and software which support these activities.

Advances in technology also drive the development of new communications and computing devices, including Personal Digital Assistants (PDAs), smart phones, e-books, telematics, and internet appliances. The availability of packetized data and the emergence of worldwide broadband communication standards provide even greater impetus for the rapid development of new communications and data processing capability.

The increased pace of progress in technology naturally leads to the need for parallel support of hardware and software development efforts. Unfortunately, hardware development traditionally precedes the creation and testing of operational software applications. To keep up with the rapid evolution of consumer activity, therefore, hardware and software development need to be decoupled, so that new hardware and software can be produced independently. Such an environment will preserve investments made in hardware and software, maximize reuse capability, ease migration to new platforms, increase software portability, consistency and security, and reduce development time formerly occupied by the integration of incompatible equipment and software.

Thus, there is a need in the art to provide separation between applications software and communications systems, such that software and hardware can be developed independently. More particularly, there is a need for an application layer interface, a method of coupling an applications subsystem and a communications subsystem, and an article, including a machine-accessible medium, which provide a mechanism to separate different physical implementations of the communications hardware environment from the applications software environment, while presenting a consistent programming interface to newly-developed applications.

### BRIEF DESCRIPTION OF THE DRAWINGS

FIG. 1 is a block diagram of an interface between an applications subsystem and a communications subsystem according to an embodiment of the present invention;

FIG. 2 is a block diagram of a communications control interface according to an embodiment of the present invention;

FIG. 3 is a block diagram of a communications control protocol according to an embodiment of the present invention;

FIG. 4 is a block diagram of an exemplary application layer interface for a unitary processor communications model, according to an embodiment of the present invention;

FIG. 5 is a block diagram of an exemplary application layer interface for a separated processor communications model, according to an embodiment of the present invention; and

FIG. 6 is a flow diagram of a method for coupling an applications subsystem to a communications subsystem according to an embodiment of the present invention.

### DESCRIPTION OF THE PREFERRED EMBODIMENTS

In the following detailed description of the invention, reference is made to the accompanying drawings which form a part hereof, and in which are shown by way of illustration, and not of limitation, specific embodiments in which the invention may be practiced. In the drawings, like numerals describe substantially similar components throughout the several views. The embodiments illustrated are described in sufficient detail to enable those skilled in the art to practice the invention. Other embodiments may be utilized and derived therefrom, such that structural and logical substitutions and changes may be made without departing from the scope of the invention. The following detailed description, therefore, is not to be taken in a limiting sense, and the scope of the invention is defined only by the appended claims, along with the full range of equivalents to which such claims are entitled.

The invention provides a scalable mechanism for abstracting network services in the form of a consistently-presented communications control interface (CCI), which is hardware-independent. In essence, across different physical configurations and across different wireless core networks, the application layer interface, including the CCI, remains constant. This occurs by abstracting the various core network capabilities (e.g., the Short Message Service, or SMS in a cellular telephone network) into sockets and/or telephony interface functions of the CCI. While different core networks, such as Global System Mobile (GSM), General Packet Radio Service (GPRS), Wideband Code Division Multiple Access (WCDMA), Code Division Multiple Access (CDMA), Time Division Multiple Access (TDMA), and Wireless Local Area Network (LAN) may provide different services, the CCI allows for technology dependent extensions to the interface.

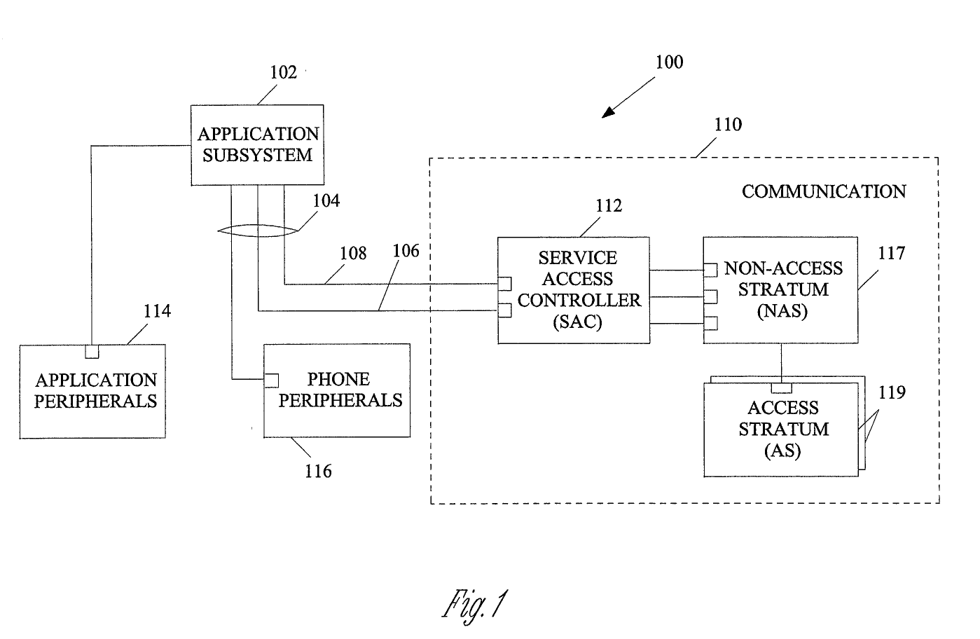

FIG. 1 is a block diagram of an interface between an applications subsystem and a communications subsystem according to an embodiment of the present invention. The Application Layer Interface (ALI) 100 may include an applications subsystem 102 capable of being communicatively coupled to a Communications Control Interface (CCI) 104, which may have, in turn, one or more sockets interfaces 106 and one or more telephony interfaces 108. The interface 100 may also include a communications subsystem 110 capable of being communicatively coupled to the CCI 104.

The communications subsystem 110, in turn, may include a Service Access Controller (SAC) 112 capable of being coupled to the applications subsystem 102 that supports the services represented by the CCI 104. The SAC 112 is primarily a control plane entity which typically provides some portion of the applications interface for telephony and sockets-based applications and/or various protocol stacks, such as, for example, a WCDMA Wireless Protocol Stack (WPS). The SAC 112 may be used in cases where the WPS is used in an Intel® PCA-compliant (i.e., Intel® Personal Internet Client Architecture) Communications Subsystem 110 to provide the application and communications separation.

As the applications interface for protocol stacks, the SAC 112 implements most of the functions defined for the server side of the CCI 104. Thus, the applications subsystem 102 gains access to communications services by making requests of the SAC 112. The SAC 112 is presented to the applications 102 as a communications port, or server. The port interface is presented by a set of application programming interfaces (APIs) implemented by the SAC 112.

The application subsystem 102 is responsible for controlling all user peripherals 114, including those that make up the phone device 116. Essentially, the CCI 104 is the API set for controlling the SAC 112 and the phone peripheral devices. Then SAC 112 abstracts the CN technologies by transforming the telephony and data (sockets) requests into the supported Non-Access Stratum (NAS) 117 services, such as circuit switched, packet, and SMS connections. The NAS in turn utilizes the CN access functionality of one or more Access Stratum (AS) 119 components.

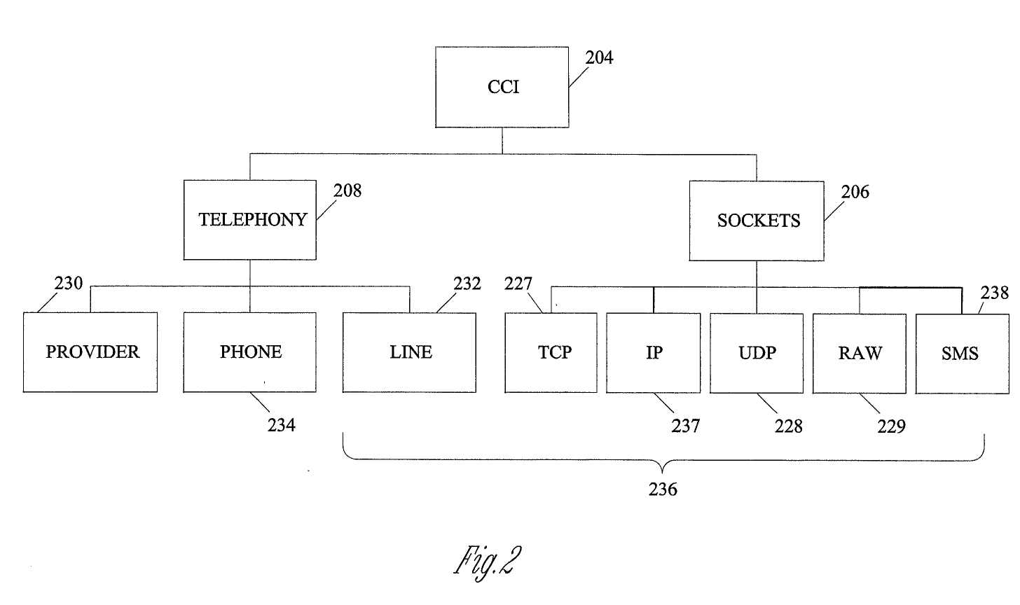

Referring now to FIG. 2, a block diagram of a CCI according to an embodiment of the present invention can be seen. As noted previously, the CCI 204 may include a sockets interface 206 and a telephony interface 208. The sockets interface 206 may include interfaces to various transport layer protocols, such as the Transfer Control Protocol (TCP) 227, the User Datagram Protocol (UDP) 228, or even a proprietary protocol 229, such as the “802.3 RAW” protocol, otherwise known as the Novell proprietary Ethernet 802.3, which includes an Institute of Electrical and Electronics Engineers (IEEE) 802.3 Length field, but not an IEEE 802.2 header. Further information regarding the IEEE 802.2 and 802.3 standards may be had by referring to: IEEE 802.2, 1998 (ISO/IEC 8802-2:1998), IEEE Standard for Information technology—Telecommunications and information exchange between systems—Local and metropolitan area networks—Specific requirements—Part 2: Logical Link Control, and IEEE 802.3, 2000 Edition (ISO/IEC 8802-3: 2000 (E)), IEEE Standard for Information technology-Telecommunications and information exchange between systems—Local and metropolitan area networks—Specific requirements—Part 3: Carrier Sense Multiple Access with Collision Detection (CSMA/CD) Access Method and Physical Layer Specifications.

CCI telephony provides access to the Core Network (CN) within the wireless domain and access to Terminal Equipment (TE) phone devices, such as a provider interface for provisioning of user's network preferences, a phone interface for access to TE devices configurable as part of the end phone set, and a line interface for access to communication services of the core network. Such services may include basic services for Plain Old Telephone Service (POTS) functionality, supplementary services for supporting additional features typical of Private Branch Exchange (PBX) operations, such as Call-Hold or Call-Forward, and extended services for extensions particular to a provisioned wireless service.

Thus, the telephony interface 208 may include a provider interface 230 and a line interface 232, and is typically capable of accessing a wireless network. The telephony interface 208 may also include a phone interface 234, which may be capable of accessing one or more terminal equipment (TE) phone devices.

It should be noted that the SAC 236 does not provide control of user devices which may be attached to the communications processor (e.g. keypad, display, microphone, earpiece). These are accessed using the phone objects 234 of the telephony interface 208 of the CCI 204; or, in the case of a single/unitary processor configuration, by the applications directly.

The SAC 236, however, may provide the functions of adaptation, encapsulation, binding, adjustment, and coordination. For example, the SAC 236 may provide adaptation of the interface provided by the underlying Radio Protocol Stack (RPS) to that defined by the CCI 204. The SAC 236 may encapsulate the Core Network (CN) within the wireless domain used to access the Public Network, hiding the type of CN used to access services from the application. This includes control of roaming between different CN types where supported by the underlying protocols. Core network types include, but are not limited to: circuit-switched, packet-switched, and short message networks.

The SAC 236 may provide binding of user plane entities within the WPS which are required to deliver services to the CCI, or binding of user and control plane entities within the WPS to external entities as indicated by the applications. The SAC 236 may also provide adjustment of Internet Protocol Suite (IPS) routing table entries (if the IPS is provisioned within the WPS) as required to deliver the service to the CCI. Finally, the SAC 236 may provide coordination of User Service Identity Module (USIM) functions, such as call control and Mobile-Originating Short Message Service (MO-SMS) control. Thus, the SAC 236 may be used to effect an interface to the TCP 227, UDP 228, and RAW 229 protocols, the internet protocol 237, and the SMS 238, as well as the line interface objects 232.

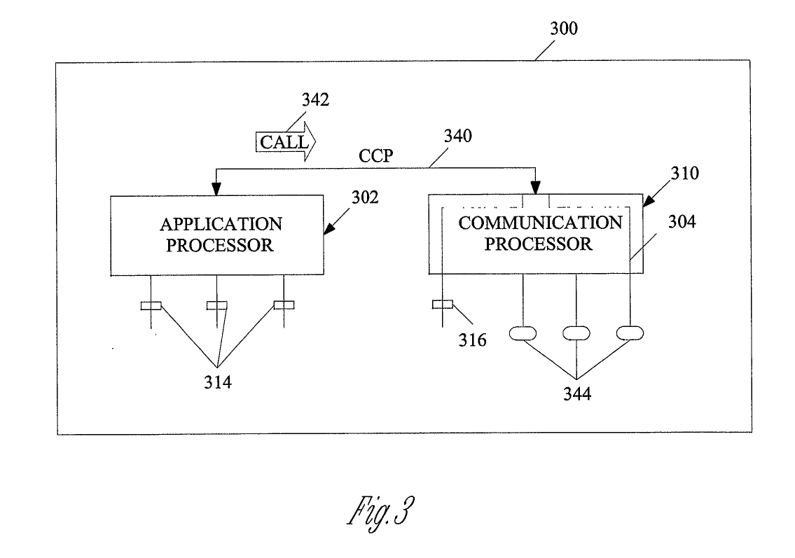

Referring now to FIG. 3, a block diagram of a Communications Control Protocol (CCP) according to an embodiment of the present invention can be seen. The ALI 300, including the CCP 340, provides facilities to allow the applications subsystem 302 to control one or more remote user devices 316 within the communications subsystem 310. The CCP 342 procedure call capability may also provide the functions of service location, protection and verification of application access to services; transportation of CCI calls and responses/events; and setup/transport of media content. Thus, it can be seen that the ALI 300 may also include a CCP 340 providing protection of an interface call 342 made by an application subsystem 302 to a communications subsystem 310. In this case, the CCP 340 provides a transparency to the application subsystem 302, such that the application subsystem 302 does not need to know the hardware configuration, promoting software-independence. The CCP 340 acts as a protocol between the two subsystems 302, 310 that facilitates access to wireless communication services provided by, for example, a communications processor within the communications subsystem 310, associated phone user devices 316, and various communications ports 344, which may include the SAC. As noted above, control of the local user devices 314 is the responsibility of the application subsystem 302.

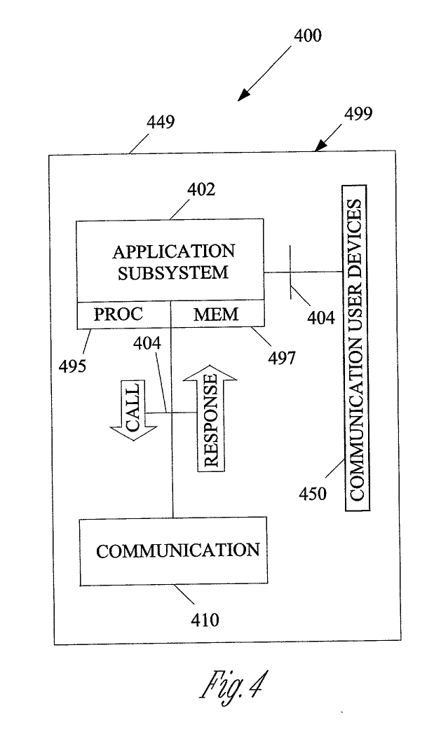

FIG. 4 is a block diagram of an exemplary ALI for a unitary or single processor communications model, according to an embodiment of the present invention. Thus the ALI 400 may include an applications subsystem 402 and communications subsystem 410 capable of being coupled to each other within a single processor module 449. Thus, as shown in FIG. 4, many of the system components may reside on the same processor 449. The Application Subsystem 402, which always uses the CCI 404; has calls mapped directly to the SAC within the communications subsystem 410, or to communication user devices 450. The CCP in this case provides the same level of service protection, but does not perform any procedure data marshalling and the client (the application subsystem 402) to server (SAC within the communications subsystem 410) end point management is performed by available local mechanisms (e.g. operating system message passing capabilities).

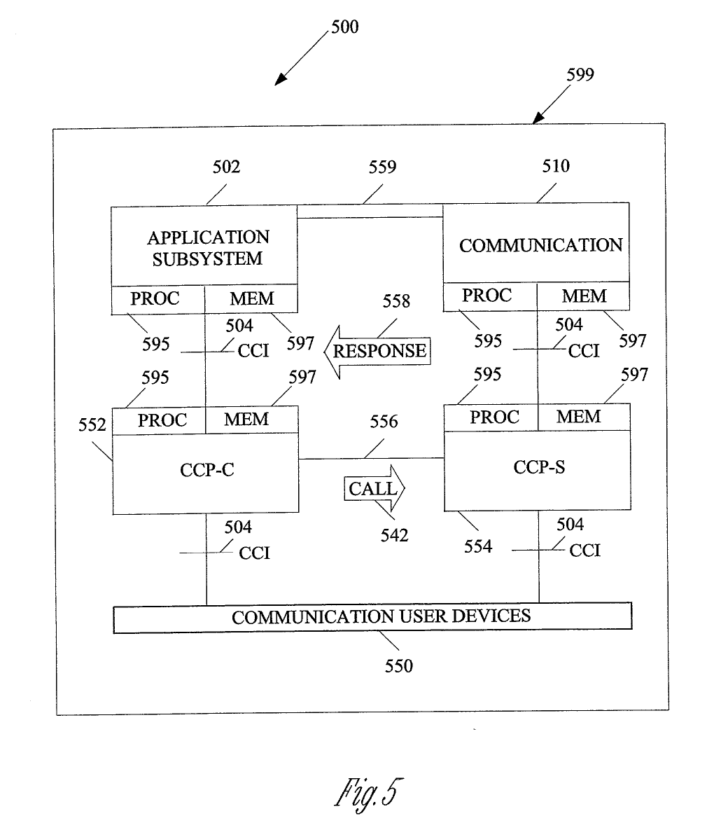

FIG. 5 is a block diagram of an exemplary ALI for a separated processor (e.g., multi-processor) communications model, according to an embodiment of the present invention. Thus, while the ALI 500 also includes an application subsystem 502 coupled to a communications subsystem 510, when the subsystems 502, 510 are physically separated, a physical and logical link (e.g., a network connection) is required between them. In this case, the application subsystem 502 makes the same CCI 504 calls; but the CCP client 552 (i.e., the CCP SAC proxy component on the client side) acts as an intermediary to send the API call 542 to the CCP server 554 (i.e., the CCP SAC stub component on the server side), typically via a network connection 556. The CCP server 554 translates the call 542 into a SAC call. The CCP 552, 554 also binds user data endpoints and transparently marshals the data across the subsystems 502, 510.

Thus, the ALI 500 may include an applications subsystem client 502 coupled to a first communications control interface (CCI) 504 having a plurality of calls 542; a communications subsystem server 510 coupled to a second CCI 504 having a plurality of responses 558; and a communications control protocol (CCP) 552, 554 coupling the applications subsystem 502 to the communications subsystem 510 and transporting the pluralities of calls 542 and responses 558 between the applications subsystem 502 and the communications subsystem 510. As noted previously, data may be transported by way of the communication user devices 550 through the CCP 552, 554 as well. In this case, the CCP 552, 554 does not marshal the data so that it is passed through unchanged, and the CCP 552, 554 provides the binding service to connect the data stream sink and source. In some implementations of the invention, the applications subsystem 502 is capable of being coupled to a first processor module, and the communications subsystem is capable of being coupled to a second processor module. In any event, the CCP 552, 554 may provide protection of the plurality of calls 542.

The ALI may further include a data link layer 559 coupled to the applications subsystem and the communications subsystem. The data link layer 559 may include an unacknowledged data transfer service, or an acknowledged data transfer service. The data link layer 559 may also provide isochronous and synchronous transport modes for the calls 542, responses 558, and for data streaming.

It should be noted that the ALI 100, 300, 400, 500; applications subsystem or processor 102, 302, 402, 502; CCI 104, 204, 304, 404, 504; sockets interfaces 106, 206; telephony interfaces 108, 208; communications subsystem 110, 310, 410, 510; SAC 112; application peripherals 114, 314; CCP 340 (and variants 552, 554); communication user devices 450, 550; and phone peripherals 116, 316 may all be characterized as “modules” herein. Such “modules” may include hardware circuitry, such as a microprocessor and/or memory, software program modules, firmware, and combinations thereof, as desired by the architect of the ALI, and appropriate for particular implementations of the invention.

One of ordinary skill in the art will understand that the ALI of the present invention can be used in other applications, and thus, the invention is not to be so limited. The illustrations of an application subsystem 102, communication subsystem 110, SAC 112, and single processor/multi-processor ALIs 400, 500, respectively, are intended to provide a general understanding of the structure of the present invention, and are not intended to serve as a complete description of all the elements and features of an ALI which might make use of the structures described herein.

Applications which may include the novel ALI of the present invention include electronic circuitry used in high-speed computers, communications ports and other equipment, modems, processor modules, embedded processors, and application-specific modules, including multilayer, multi-chip modules. Such implementations of the ALI may further be included as sub-components within a variety of electronic systems, such as televisions, cellular telephones, personal computers, networked computers, servers, and clients, personal radios, automobiles, aircraft, and others.

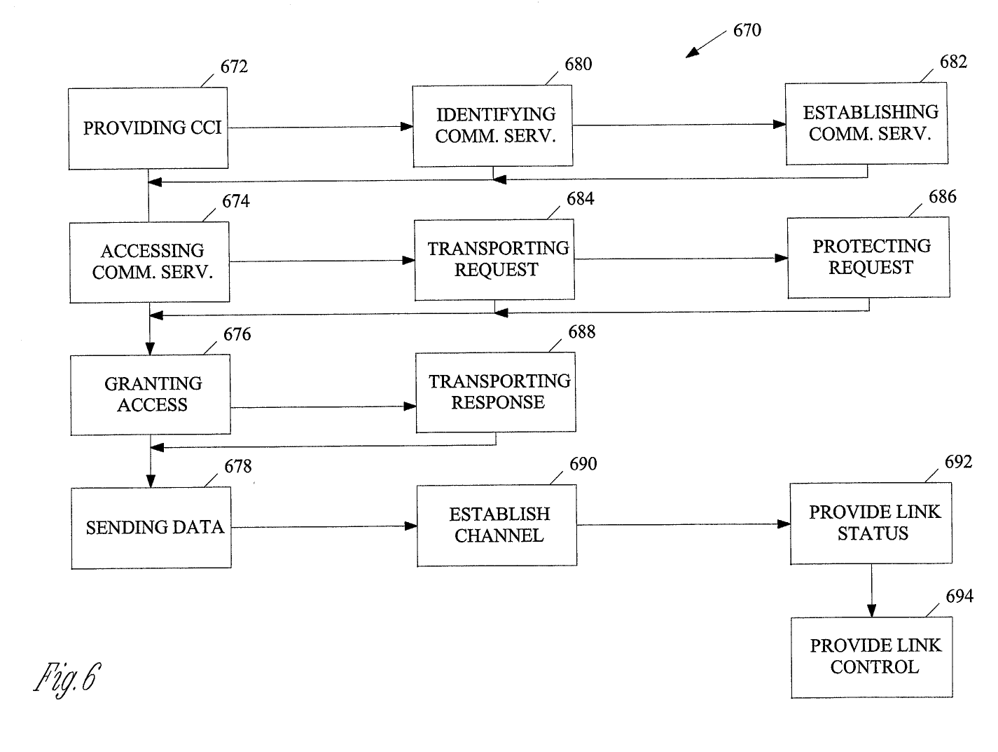

FIG. 6 is a flow chart of a method of coupling an applications subsystem to a communications subsystem according to an embodiment of the present invention. The method 670 may include providing a CCI between the applications subsystem and the communications subsystem at block 672; and accessing a communications service by using the CCI to send a request to use the communications service to a SAC at block 674. Typically, the SAC will be coupled to the communications subsystem.

The method 670 may then continue with granting access to the communications service by using the CCI to send a response from the SAC to the applications subsystem at block 676; and exchanging data between the applications subsystem and the communications subsystem using a data transport channel at block 678. Typically, the data transport channel is coupled to the applications subsystem and the communications subsystem.

When the ALI is implemented using a separated or multi-processor system, such as when the applications subsystem is coupled to a first processor, and the communications subsystem is coupled to a second processor, a CCP may be used to identify the communications service at block 680, and establish the communications service at block 682 (prior to accessing the service at block 674). Establishing the service assumes that an end-to-end link exists, as is well known to those skilled in the art. Further, prior to granting access at block 676, the CCP may be used to transport the request from the applications subsystem to the communications subsystem at block 684, and protect the request during transport at block 686. The response to the request may thereafter be transported from the communications subsystem to the applications subsystem using the CCP at block 688.

Finally, sending the data at block 678 may include using a CCP to establish the data transport channel at block 690; provide link status for the data transport channel at block 692, and provide link control for the data transport channel at block 694.

One of ordinary skill in the art will understand, upon reading and comprehending this disclosure, the manner in which a software program can be launched from a computer readable medium in a computer based system to execute the functions defined in the software program. One of ordinary skill in the art will further understand the various programming languages which may be employed to create one or more software programs designed to implement and perform the methods of the present invention. The programs can be structured in an object-orientated format using an object-oriented language such as Java, Smalltalk, or C++. Alternatively, the programs can be structured in a procedure-orientated format using a procedural language, such as COBOL or C.

Software components or modules may communicate using any of a number of mechanisms, such as application program interfaces (API) or interprocess communication techniques such as the Remote Procedure Call (RPC), Common Object Request Broker Architecture (CORBA), Component Object Model (COM), Distributed Component Object Model (DCOM), Distributed System Object Model (DSOM), and Remote Method Invocation (RMI). However, the teachings of the present invention are not limited to any particular programming language or environment, including Hypertext Markup Language (HTML) and Extensible Markup Language (XML).

As is evident from the preceding description, and referring back to FIGS. 4 and 5, it can be seen that one or more processors 495, 595 typically access at least some form of computer-readable media, such as one or more memories 497, 597. However, it should be understood that computer-readable and/or accessible media may be any available media that can be accessed by the processor(s) 497, 597, including, by way of example and not limitation, computer storage media and communications media. Computer storage media includes volatile and non-volatile, removable and non-removable media implemented in any method or technology for storage of information such as computer-readable instructions, data structures, program modules or other data. Communications media specifically embodies computer-readable instructions, data structures, program modules or other data in a modulated data signal such as a carrier wave, coded information signal, and/or other transport mechanism, which includes any information delivery media. The term “modulated data signal” means a signal that has one or more of its characteristics set or changed in such a manner as to encode information in the signal. By way of example and not limitation, communications media also includes wired media such as a wired network or direct-wired connections, and wireless media such as acoustic, optical, radio frequency, infrared and other wireless media. Combinations of any of the above are also be included within the scope of computer-readable and/or accessible media.

Thus, it is now easily understood that another embodiment of the invention may include an article 499, 599 comprising a machine-accessible medium having associated data, wherein the data, when accessed, results in a machine (e.g. a processor or computer) performing activities such as providing a CCI between the applications subsystem and the communications subsystem, accessing a communications service by sending a CCI communications service request to the SAC coupled to the communications subsystem, granting access to the communications service by sending a CCI response from the SAC to the applications subsystem, and exchanging data between the applications subsystem and the communications subsystem using a data transport channel (typically coupled to the applications subsystem and the communications subsystem).

Of course, referring to the exemplary methods described above, it should be understood that the activities performed may also include, for example, verifying the request to use the communications service using a CCP, and protecting the request to use the communications service using the CCP.

Thus, the ALI of the invention provides support for parallel, decoupled development of hardware and software which preserves prior investment by encouraging reuse, easing migration to new platforms, and increasing software portability. Code consistency and security are also maintained, while development time formerly occupied by the integration of incompatible equipment and software is reduced. These fortuitous circumstances may occur as a result of using the ALI of the present invention as a mechanism to separate different physical implementations of a communications hardware environment from the applications software environment, while enabling the presentation of a consistent programming interface to newly-developed applications.

Although specific embodiments have been illustrated and described herein, those of ordinary skill in the art will appreciate that any arrangement which is calculated to achieve the same purpose may be substituted for the specific embodiments shown. This disclosure is intended to cover any and all adaptations or variations of the present invention. It is to be understood that the above description has been made in an illustrative fashion, and not a restrictive one. Combinations of the above embodiments, and other embodiments not specifically described herein will be apparent to those of skill in the art upon reviewing the above description. The scope of the invention includes any other applications in which the above structures, interfaces, and protocols are used. The scope of the invention should be determined with reference to the appended claims, along with the full range of equivalents to which such claims are entitled.

W hat is claimed is:

1. An application layer interface, comprising:
an applications subsystem;
a communications control interface (CCI) capable of being communicatively coupled to the applications subsystem and providing abstracted services to the applications subsystem; and
a communications subsystem capable of being communicatively coupled to the CCI and a core network including core network services which are transformed into the abstracted services by the CCI.

2. The application layer interface of claim 1, wherein the communications subsystem includes a service access controller capable of being coupled to the applications subsystem.

3. The application layer interface of claim 2, wherein the CCI includes a sockets interface and a telephony interface, and wherein the service access controller is capable of being coupled to the sockets interface and the telephony interface.

4. The application layer interface of claim 1, wherein the CCI includes a telephony interface, and wherein the telephony interface includes a provider interface and a line interface and is capable of accessing a wireless network.

5. The application layer interface of claim 1, wherein the CCI includes a telephony interface, and wherein the telephony interface includes a phone interface capable of accessing at least one terminal equipment phone device.

6. The application layer interface of claim 1, further including:
a communications control protocol providing protection of an interface call made by the application subsystem to the communications subsystem.

7. The application layer interface of claim 1, wherein the applications subsystem is capable of being coupled to a single processor module, and wherein the communications subsystem is capable of being coupled to the single processor module.

8. The application layer interface of claim 1, wherein the core network is a selected one of Global System Mobile (GSM), General Packet Radio Service (GPRS), Wideband Code Division Multiple Access (WCDMA), Code Division Multiple Access (CDMA), Time Division Multiple Access (TDMA), and Wireless Local Area Network (LAN).

9. An application layer interface, comprising:
an applications subsystem client coupled to a first communications control interface (CCI) having a plurality of calls;
a communications subsystem server coupled to a second CCI having a plurality of responses; and
a communications control protocol (CCP) coupling the applications subsystem to the communications subsystem and transporting the pluralities of calls and responses between the applications subsystem and the communications subsystem.

10. The application layer interface of claim 9, wherein the applications subsystem is capable of being coupled to a first processor module, and wherein the communications subsystem is capable of being coupled to a second processor module.

11. The application layer interface of claim 9, wherein the CCP provides protection of the plurality of calls.

12. The application layer interface of claim 9, further comprising:
a data link layer coupled to the applications subsystem and the communications subsystem, wherein the data link layer includes an unacknowledged data transfer service.

13. The application layer interface of claim 9, further comprising:
a data link layer coupled to the applications subsystem and the communications subsystem, wherein the data link layer provides an acknowledged data transfer service.

14. The application layer interface of claim 9, further comprising:
a data link layer coupled to the applications subsystem and the communications subsystem, wherein the data link layer provides isochronous and synchronous transport modes.

15. The application layer interface of claim 9, wherein the CCI is capable of being coupled to a core network having core network services which are transformed by the CCI into abstracted services for use by the applications subsystem client.

16. A method comprising:
providing a communications control interface (CCI) between an applications subsystem and a communications subsystem;
accessing a communications service by using the CCI to send a request to use the communications service to a service access controller (SAC) coupled to the communications subsystem;
granting access to the communications service by using the CCI to send a response from the SAC to the applications subsystem; and
exchanging data between the applications subsystem and the communications subsystem using a data transport channel coupled to the applications subsystem and the communications subsystem.

17. The method of claim 16, further comprising:
protecting the request to use the communications service using a communications control protocol.

18. The method of claim 16, further comprising:
identifying the communications service using a communications control protocol.

19. The method of claim 16, further comprising:
establishing the communications service using a communications control protocol.

20. The method of claim 16, further comprising:
transporting the request from the applications subsystem to the communications subsystem using a communications control protocol.

21. The method of claim 16, further comprising:
transporting the response from the communications subsystem to the applications subsystem using a communications control protocol.

22. The method of claim 16, further comprising:
establishing the data transport channel using a communications control protocol.

23. The method of claim 16, further comprising:
providing a link status for the data transport channel using a communications control protocol.

24. The method of claim 16, further comprising:
providing a link control for the data transport channel using a communications control protocol.

25. An article comprising a machine-accessible medium having associated data, wherein the data, when accessed, results in a machine performing:
providing a communications control interface (CCI) between an applications subsystem and a communications subsystem;
accessing a communications service by using the CCI to send a request to use the communications service to a service access controller (SAC) coupled to the communications subsystem;
granting access to the communications service by using the CCI to send a response from the SAC to the applications subsystem; and
exchanging data between the applications subsystem and the communications subsystem using a data transport channel coupled to the applications subsystem and the communications subsystem.

26. The article of claim 25, wherein the machine-accessible medium further includes data, which when accessed by the machine, results in the machine performing:
protecting the request to use the communications service using a communications control protocol.

27. The article of claim 25, wherein the machine-accessible medium further includes data, which when accessed by the machine, results in the machine performing:
verifying the request to use the communications service using a communications control protocol.

28. The article of claim 25, wherein the communications service is transformed into an abstracted service by the CCI for use by the applications subsystem.
